(19) United States
(12) Patent Application Publication
(10) Pub. No.: US 2011/0006677 A1
(43) Pub. Date: Jan. 13, 2011

(54) ARC TUBE WITH END STRUCTURE

(75) Inventors: Roland Huettinger, Kaufering (DE); Khanh Pham Gia, Neubiberg (DE); Steffen Walter, Oberpframmern (DE); George C. Wei, Weston, MA (US)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/677,135

(22) PCT Filed: Sep. 18, 2008
(86) PCT No.: PCT/US2008/076809

§ 371 Date: Mar. 9, 2010

Related U.S. Application Data
(60) Provisional application No. 60/973,196, filed on Sep. 18, 2007.

(51) Int. Cl. H01J 61/30; H01J 9/26

(52) U.S. Cl. 313/634; 445/26

(57) ABSTRACT

An arc tube of ceramic material has an aluminum nitride (AlN) end structure (36) wherein a feedthrough (30) is sealed by direct bonding. Said feedthrough is comprised of a refractory metal, W or Mo, that is aluminized on its outer surface. Preferably, the feedthrough is a Mo pipe that had been provided with a Mo3191Al layer (36) prior to direct bonding, the aluminized layer provides a bonding interface between the AlN ceramic and the refractory metal feedthrough.

### TECHNICAL FIELD

This invention relates to an arc tube with an end structure, and to a method of making such an arc tube.

### BACKGROUND ART

European Patent Application No. EP 371315 describes the use of aluminum nitride (AlN) as a material for the arc tube of a metal halide lamp. It suggests to take advantage of a Mo pipe as a feedthrough.

A similar technique is described in International Patent Application No. WO 2003/060952. Here the AlN arc tube is closed by a plug made of Mo or W and by means of a fusion joint made from a compound of the type Mo—Al, for example Al₈Mo₃ and AlMo₃.

German Patent Application No. DE-Az 102006052761.5 (not yet published) discloses a metal-ceramic joint formed through reactive process, in which the surface areas of Mo pipes were aluminized to become Mo₃Al phase and the aluminized Mo pipes were co-fired to graded rings of an alumina-Mo cermet and PCA (translucent polycrystalline alumina). However such a technique may turn out to suffer from difficulties with intrinsic mismatch of thermal expansion and elastic modulus among Mo, cermet, and PCA.

A metallised scheme of bonding Mo to already sintered AlN is known from U.S. Pat. No. 6,762,496, for example. The metallization utilizes a paste of Mo particles mixed with AlN powder plus sintering aids such as CaO or yttria, which is applied to the gap of AlN—Mo, followed by heat treatment. The Mo—AlN—CaO/Y₂O₃-paste has been used in AlN substrates for many years.

### SUMMARY OF THE INVENTION

It is an object of the present invention to achieve a long lasting hermetic seal between the end structure of an arc tube and a refractory metal feedthrough system, said feedthrough being made from a refractory metal, RM, out of the group Mo or W.

This object is achieved by providing the feedthrough with a RM-Al layer and making the end structure out of AlN. After co-sintering, there is provided a direct bonding between the aluminized RM and the AlN end structure.

A further object is to indicate a method for providing such a direct bonding. Such a method is realized by the following steps:
(a) providing a pre-fired end structure having an opening and being made of AlN and providing a feedthrough made of Mo or W;
(b) aluminizing the feedthrough on its outer surface;
(c) placing the feedthrough inside the opening in the end structure; and
(d) co-sintering the AlN end structure together with the aluminized feedthrough at 1800° C. to 1950° C. for 30 minutes to 20 hours to achieve a vacuum-tight direct seal.

The AlN end structure used to form the seal is often a plug of AlN having an opening to receive the feedthrough. The arc tube also can be made of AlN, but this is not a necessary feature. A preferred embodiment is an arc tube made of AlN with integrally formed capillaries as the end structure. A metal halide lamp takes advantage of such an AlN arc tube filled with metal halides as being well known like Na iodide, Sc iodide, rare earth halides, Ca iodide and thallium iodide.

Relative to glass frit sealing, the co-fired, frit-less parts have the following advantages: (1) flexibility for the temperature of the end structure, since the conventional Dy₂O₃—SiO₂—Al₂O₃ frit seal is limited to below 800° C. for rare earth halide fills, and (2) a “cold” sealing (welding) scheme rather than melting/solidification of the glass frits, is possible.

A particularly advantageous arrangement is achieved when the feedthrough is comprised of molybdenum. The advantages of this arrangement include: (1) significantly improved bonding and hermeticity for the co-fired AlN-aluminized Mo interface vs. that of AlN-pure Mo; (2) AlN as the tube body, and the fritless construction of co-fired aluminized Mo, allows better durability of lamps and offers the possibility of new and more aggressive fills at even higher temperatures than the current PCA lamps; (3) co-sintered aluminized Mo pipe would remove the constraint of the limit in the upper temperature of frit seals; and (4) the sealing scheme of the co-fired AlN-tube-aluminized-Mo-pipe, involves a “cold” process (i.e. welding of Mo pipes) rather than high-temperature glass frit melting/solidification process for the current PCA lamps.

### BRIEF DESCRIPTION OF THE DRAWINGS

In the following text, the invention is to be explained in more detail by using a number of exemplary embodiments. In the figures:

FIG. 1 shows a metal halide lamp, schematically;

FIG. 2 shows an embodiment of the end of the vessel;

FIG. 3 shows another embodiment of the end of the vessel in detail;

FIG. 4 shows a further embodiment of the end of the vessel in detail.

### DETAILED DESCRIPTION OF THE INVENTION

A preferred embodiment of the present invention utilizes aluminized Mo pipes and co-firing with AlN, which has a favorable expansion match with the base Mo metal. The results show significant improvements in the direct bonding, without frits, between the aluminized Mo and AlN wall versus that of pure Mo and AlN, along with high transmittance. The parts and method of making the parts have considerable promise and advantages over co-firing of translucent AlN and pure Mo.

The co-firing of pure Mo pipe to an AlN capillary results in a gap present at the interference bond between the pure Mo and AlN. This is probably due to the evaporation of AlN and reaction of pure Mo with the CaO and/or Y₂O₃ sintering aids in the AlN. Thus the formation of a hermetic seal by a direct co-fired bond is hindered.

In order to overcome this problem, a Mo pipe was co-fired with an AlN capillary after pre-treatment of the Mo pipe to establish an aluminized layer on the Mo surface. At first said layer is made of Mo₃Al on the surface of the aluminized Mo pipe. The layer then becomes a dual-phase, dense structure of an AlN—Mo(˜1% Al) composite after co-sintering. This likely occurs because Mo₃Al loses Al to become Mo containing a smaller level of Al, at high temperatures (1800-1950° C.). When co-sintering with AlN, the Al released from the Mo₃Al reacts with the nitrogen sintering atmosphere to form an AlN phase in-situ in the layer abutting the Mo. During the course of the co-sintering, the AlN shrinks upon the aluminized Mo pipe resulting in an about 6-30% (preferably 17-24%) co-firing interference process.

A process for forming an aluminized Mo feedthrough is described in International Patent Application No. WO 2007/065827, which is incorporated herein by reference. By means of an “Alitierung” process, which is also known as an “Alumetierung” process, aluminium, which is reactive, is brought into the surface of the feedthrough made of molybdenum via the gas phase. This process starts with creation of a Mo₃Al₈ layer which is external. This happens in a diffusion process which depends on time and temperature. For this purpose, Mo tubes are laid into an aluminum-containing powder bed blend. They are then annealed under temperatures of between 800° C. and 1200° C. in a protective gas atmosphere. Thus, a gradient structure is generated on the surface of the Mo basic material consisting of an aluminium-rich Al₈Mo₃ phase, adjacent to an inner layer comprising a phase that has a lower aluminium content, and preferably consisting of Mo₃Al, which then leads into the pure Mo of the tube.

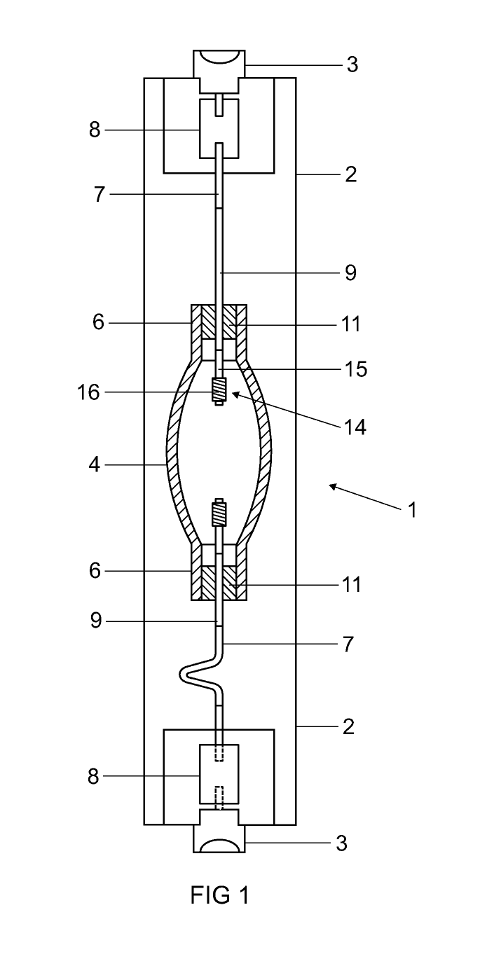

FIG. 1 shows an illustration of a metal halide lamp 1. It comprises a tubular-like ceramic discharge vessel with two electrodes 14 inserted therein. Electrodes 14 are comprised of shaft 15 and coil 16. The discharge vessel consists of a central bulgy part 4 and two ends 6. Preferably, the vessel is made of AlN. A feedthrough 9 connects the electrode 14 and its shaft 15 with an external lead 7. The feedthrough is a Mo rod contained inside a Mo pipe held in an AlN plug 11. The feedthrough 9 and electrode 14 together comprise an electrode system. The vessel is enclosed in an outer bulb 2 with a pinch seal having a foil 8 enclosed. The outer bulb is provided with a base 3.

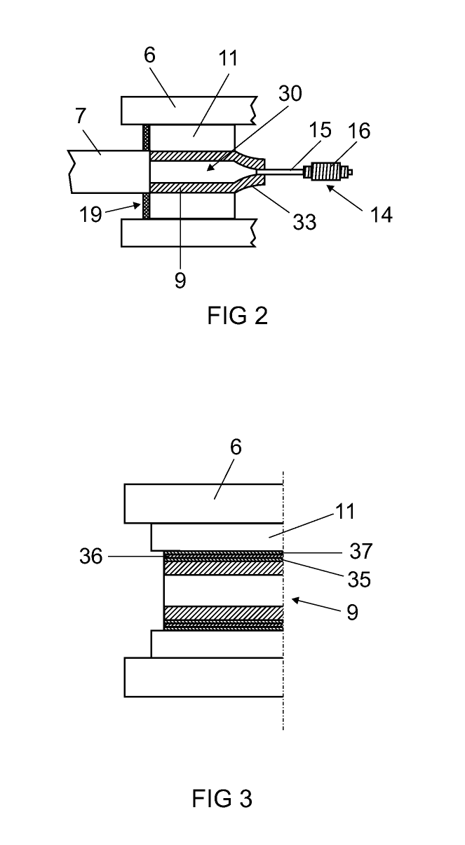

FIG. 2 shows in more detail the end 6 of the vessel. In a preferred embodiment the feedthrough is a Mo pipe 30 that is directly sintered to the plug 11. To minimize the chance of fracture of the junction of Mo pipe 30 and AlN plug 11 during handling, a frit seal 19 can be applied to the outer surface of the plug as a filler to create a smoothly curved joint instead of a nearly perpendicular joint. Such kinds of frit seal fillers are well known in the state of the art.

FIG. 3 shows in even more detail that the Mo pipe 30 has an aluminized layer on its surface to improve adhesion to the plug which is made of AlN. The composition of the AlN-based plug can either be the same as the AlN vessel or it could be a cermet consisting of AlN—Mo (or W) doped with CaO and/or Y₂O₃ sintering aids. An aluminum-containing layer 35 is directly applied to the Mo pipe, and a second layer 36 is built up on it. Said layer 36 is made of Mo₃Al on the surface of the aluminized Mo pipe. It becomes a dual-phase, dense structure of an AlN and Mo (˜1% Al) composite after co-sintering. The AlN shrinks upon the aluminized Mo during the course of co-firing interference process. A third layer 37 is the boundary layer to the plug 11.

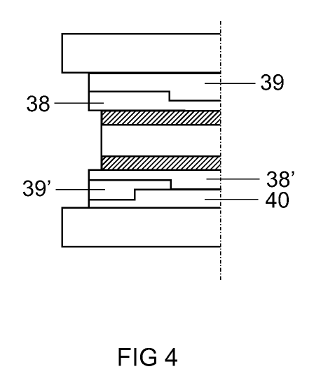

FIG. 4 shows a plug which is made of several parts 38, 39 which may have different compositions. The composition of the AlN-based plug can be a single or graded cermet consisting of AlN—Mo (or W) doped with CaO and/or Y₂O₃ sintering aids, without or with graded contents of Mo or W to make thermal expansions even more compatible with one another than the case of a single composition identical to the vessel.

In another embodiment a different end structure is used. It uses a Mo pipe together with a plug which is constructed as a hat that fits over the end of the capillary of a discharge vessel. The hat again is made of AlN. The advantage is that the AlN hat-Mo pipe can be pre-shrunk to fit the capillary of an already-sintered AlN vessel of high transmittance, and then the entire assembly goes through a second firing to produce the final-sintered part.

These embodiments are based on a consideration of thermal expansion matching compatibility. The average thermal expansion coefficients of AlN, Mo, and W, are 5.1, 5.6, and 4.6×10⁻⁶/° C., respectively. The thermal expansion of Mo₃Al is known to be somewhere between 5.7×10⁻⁶/° C. and 6.6×10⁻⁶/° C. The thermal expansions of pertinent materials are listed in Table 1. The 2000K data pertains to fabrication of the direct-bonded AlN-aluminized-Mo-pipe structure which requires a co-firing temperature as high as 2073-2223K. The 1000K data are relevant to lamp on-and-off operation during which the vessel temperature reaches ˜1300K and the capillary end temperature reaches ˜1000K. The 1000K expansion data of Mo₃Al listed in Table 1, was a measured value, while the 2000K data of Mo₃Al in the same Table was extrapolated.

TABLE 1

| | Expansion | Expansion |
|---|---|---|
| | ΔL/L (%) at | ΔL/L (%) at |
| Material | 1000 K | 2000 K |
| Mo | 0.385 | 1.145 |
| W | 0.339 | 0.893 |
| Nb | 0.561 | 1.488 |
| Mo₃Al | 0.526 | 1.473 |
| AlN | 0.345 | 0.840 |
| Al₂O₃ | 0.565 | 1.370 |

Table 2 shows results for several embodiments. The wall thickness of the AlN vessel was 0.85 mm. First column indicates the number of the sample. Second and third columns refer to the aluminized Mo pipe and disclose the outer diameter OD and the inner diameter ID in mm. Column 4 indicates the leak tightness. Leak tightness was <5×10⁻⁹ atm cm³/s for sample 1 and <9×10⁻⁹ atm cm³/s for samples 2 to 5. Column 5 shows the total transmittance in percent. Column 6 shows the type of end construction (with or without additional frit seal).

TABLE 2

| | | | Leak | AlN | |
|---|---|---|---|---|---|
| sample | OD | ID | tight | transmittance | End construction |
| 1 | 1 mm | 0.7 mm | yes | 62.3% | Only co-fired |
| 2 | 1 mm | 0.7 mm | yes | 67.7% | Only co-fired |
| 3 | 1 mm | 0.7 mm | yes | 74.8% | Only co-fired |
| 4 | 0.9 mm | 0.7 mm | yes | 85.9% | Co-fired and frit sealed |
| | | | | | at top of co-fired end |
| 5 | 0.9 mm | 0.7 mm | yes | 86.0% | Co-fired and frit sealed |
| | | | | | at top of co-fired end |

Conditions for sintering all samples were the same. Sintering happened under N₂-10% H₂ in a W element, Mo shielded furnace. A typical sinter temperature is 1850° C. to 2000° C. for several hours with a ramp time again of several hours.

The outer diameter (OD) surfaces of the Mo pipes (0.9-1.0 mm OD by 0.7 mm inner diameter, ID, by 12-16 mm long) were aluminized. The Mo₃Al layer on the surface was between 0.1 and 0.6 mm thick, preferably about 0.2-0.4 mm (or 200-400 μm) thick. With this kind of thickness, the actual expansion of the aluminized Mo is estimated to be about 5.9×10⁻⁶/° C., only slightly higher than that of pure Mo (5.6×10⁻⁶/° C.). Tungsten pipes could also be aluminized and used for AlN vessels.

The pre-fired AlN tubes were made by starting with AlN powder doped with 1-3 wt % CaO-based sintering. The powder was mixed with wax, and shaped to form bulgy tubes of 70 W PCA bulgy size ceramic tubes with a sintered wall thickness of 0.6 to 0.85 mm. The parts were de-bind and pre-fired in air prior to sintering.

The aluminized Mo pipes were placed inside the prefired capillaries—for example 70 W size, which sinters to 0.76 mm ID—at both ends of the pre-fired AlN tubes to a pre-determined position—for example about 6-8 mm length of the co-fired bond—vertically. The positioning was assisted by Mo wires horizontally attached to the outside of the aluminized Mo pipes. The assembled parts were placed in Mo fixtures, in a Mo cup with a Mo cover. Co-sintering was conducted in a W-element, Mo-shield furnace under N₂—H₂ at 1850-1950° C. for 1-4 h, to a vacuum-tight direct seal. This shows the feasibility of the AlN tube-aluminized Mo pipe direct joint via co-sintering. During sintering, samples could be buried in a setter powder of AlN particles doped with sintering aids in order to minimize evaporation of AlN, which is detrimental to densification. The AlN shrank upon the aluminized Mo tube during the course of the co-firing interference process (capillary ID shrank from ˜1.05 mm to ˜0.76 mm pushing against the ˜0.9-1.0 mm OD of aluminized Mo).

Relative to pure Mo pipe, the aluminized Mo helps to form a better bond between co-fired AlN and Mo. It is believed that as Mo₃Al decomposes a little, the Al vapor released from Mo₃Al helps cut down evaporation and decomposition of AlN immediately adjacent to the Mo₃Al—Mo, and reacts with nitrogen in the N₂—H₂ sintering atmosphere to form AlN in-situ, thereby resulting in a better bond than the case of AlN—Mo alone.

In some cases, the thickness (˜0.4 μm) of the Mo₃Al might have been too great such that microcracks formed in AlN at the end of the aluminized Mo pipe. The insertion depth of the aluminized Mo pipe inside the AlN capillary also affects the tendency of such microcracking; a shorter overlap should give a better chance of being crack-free and leak-tight. The microcracking is related to (1) the depth of the co-firing bond, (2) thickness of the aluminized layer, (3) thermal expansion match among the aluminized layer, Mo, and AlN, and (4) the heating rate. Thermal expansion of Mo₃Al is ˜20% higher than that of Mo or ˜10% higher than AlN; a smaller thickness of the aluminized layer would be better. The ramp time was set at 4 h so that a full run could be done in one day (8 h). The heating rate could be further decreased to allow a higher creep deformation rate relative to the densification rate, which would help prevent microcrack formation.

The total transmittance measurement involves placing a fiber-optical source inside the sintered PCA tube and measuring the total amount of diffuse light transmitted and integrated over a sphere. Table 2 shows transmittance as high as 86% in 0.85 mm-thick-wall parts was achieved. Geometrically equivalent, state-of-the-art PCA parts, have about 95% total transmittance. A thinner wall in the AlN vessel will yield a higher transmittance. It turned out that sintering in N₂—H₂ can produce AlN tubes of >92% transmittance. Co-firing could also be conducted under flowing nitrogen gas in a carbon-element furnace.

In several cases, the bottom AlN capillary-aluminized Mo pipe bond of the co-fired structure was leak-tight, but the top AlN capillary-aluminized Mo pipe bond was leaky. This was thought to be due to a higher weight loss at the top capillary vs. the bottom capillary during sintering. A higher weight loss would increase the chance of missing the desired interference, and thereby causing leaks. Ways to suppress decomposition of the top AlN leg including the use of an AlN dome shield and a Mo tube shield, were found to be helpful. Alternatively, the leaky top capillary-Mo pipe bond could be repaired by melting and solidification of HCl frit (Dy₂O₃—Al₂O₃—SiO₂) at the interface. Table 2 shows samples 1 to 3 were co-fired and leak-tight at both ends in as-made state, while samples 4 to 5 were co-fired and then frit-sealed (in-between Mo pipe and AlN capillary) at the top leg.

Scanning electron micrographs of polished cross section of the co-fired aluminized Mo to AlN capillary show that the Mo₃Al layer on the surface of the aluminized Mo pipe, became a dual-phase, dense structure of a AlN—Mo(˜1% Al) composite after co-sintering. The Mo (˜1% Al) phase instead of the original Mo₃Al was ascertained via electron microprobe quantitative analysis. The bond at the interface of aluminized Mo and AlN involved an intimately mixed assemblage of an AlN phase and a Mo (˜1% Al) phase. The original Mo₃Al layer on Mo, appeared to have lost Al or have reacted with AlN to become Al-containing Mo interdispersed with an AlN network that might have formed in-situ from the nitriding reaction of the Al vapor with N₂ in the co-firing atmosphere.

While there have been shown and described what are at present considered to be preferred embodiments of the invention, it will be apparent to those skilled in the art that various changes and modifications can be made herein without departing from the scope of the invention as defined by the appended claims.

What is claimed is:

1. A ceramic arc tube having an end structure made of AlN, said arc tube being provided with an electrode system and a ionizable fill, said electrode system having a feedthrough which is arranged in the end structure, said feedthrough being comprised of a refractory metal RM selected from Mo or W, wherein said feedthrough is provided with a RM-Al layer and there is provided a direct bonding between the RM-Al layer and the end structure.

2. Ceramic arc tube in accordance with claim 1, wherein said end structure is a capillary.

3. Ceramic arc tube in accordance with claim 1, wherein said feedthrough is a Mo tube.

4. Ceramic arc tube in accordance with claim 1, wherein said feedthrough is comprised of Mo and said RM-Al layer is an aluminized layer originally containing Mo₃Al.

5. Ceramic arc tube in accordance with claim 1, wherein the insertion depth of the feedthrough in the end structure is 3 to 8 mm.

6. Ceramic arc tube in accordance with claim 1, wherein the thickness of the RM-Al layer is 0.2 to 0.4 mm.

7. Ceramic arc tube in accordance with claim 3, wherein said RM-Al layer is an aluminized layer originally containing Mo₃Al.

8. Ceramic arc tube in accordance with claim 7, wherein the thickness of the RM-Al layer is 0.2 to 0.4 mm.

9. A method of providing a hermetic seal in a ceramic arc tube, the method comprising:
(a) providing a pre-fired end structure having an opening and being made of AlN and providing a feedthrough made of Mo or W;
(b) aluminizing the feedthrough on its outer surface;
(c) placing the feedthrough inside the opening in the end structure; and
(d) co-sintering the AlN end structure together with the aluminized feedthrough at 1800° C. to 1950° C. for 30 minutes to 20 hours to achieve a vacuum-tight direct seal.

10. The method of claim 9, wherein said co-sintering is accomplished in a N₂—H₂ atmosphere.

11. The method of claim 9, wherein the co-sintering is for 1 to 4 hours.
